(19) United States
(12) Patent Application Publication
(10) Pub. No.: US 2008/0143176 A1
(43) Pub. Date: Jun. 19, 2008

(54) Anti-Reverse Safety Device for Hydraulic Cylinder of Wheeled Vehicle

(76) Inventor: Wei-Teh Hsu, Tung Shan Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/928,284

(22) Filed: Oct. 30, 2007

(30) Foreign Application Priority Data
Dec. 15, 2006 (TW) 095222156

(51) Int. Cl. B60T 17/16

(52) U.S. Cl. 303/89

(57) ABSTRACT

A wheeled vehicle includes a cylinder having a receiving chamber, a retractable piston rod movably mounted on the cylinder to support a bearing seat, and an anti-reverse safety device mounted on the cylinder to provide an anti-reverse effect to the cylinder. Thus, when the piston rod is pressed downward, the anti-reverse safety device provides an anti-reverse effect to the cylinder to prevent the fluid in the receiving chamber of the cylinder from flowing backward, so that the bearing seat is fixed at a normal position without being lowered down accidentally.

### BACKGROUND OF THE INVENTION

1. Field of the Invention

The present invention relates to an anti-reverse safety device and, more particularly, to an anti-reverse safety device for a hydraulic cylinder of a wheeled vehicle, such as a truck and the like.

2. Description of the Related Art

A conventional wheeled vehicle, such as a truck and the like, comprises a vehicle body, a bearing seat pivotally mounted on the vehicle body, a hydraulic cylinder mounted on the vehicle body and having an inside having a receiving chamber to receive a hydraulic fluid, and a retractable piston rod movably mounted on the hydraulic cylinder and connected with the bearing seat to perform a linear displacement motion by control of the hydraulic fluid contained in the receiving chamber of the hydraulic cylinder so that the hydraulic cylinder is disposed between an extended position to extend the bearing seat and a retracted position to retract the bearing seat so as to adjust an inclined angle of the bearing seat relative to the vehicle body. However, the hydraulic cylinder is not provided with a safety valve so that the bearing seat easily falls down accidentally when the hydraulic cylinder is worn out or out of control, thereby causing danger to the operator and the vehicle body under the bearing seat.

### BRIEF SUMMARY OF THE INVENTION

In accordance with the present invention, there is provided a wheeled vehicle, comprising a cylinder having an inside having a receiving chamber, a first fluid supply line mounted on the cylinder and connected to the receiving chamber of the cylinder, a retractable piston rod movably mounted on the cylinder to perform a linear displacement motion so that the cylinder is disposed between an extended position and a retracted position, and an anti-reverse safety device mounted on the cylinder to provide an anti-reverse effect to the cylinder to prevent the cylinder from moving from the extended position into the retracted position automatically.

The primary objective of the present invention is to provide an anti-reverse safety device for a hydraulic cylinder of a wheeled vehicle.

Another objective of the present invention is to provide an anti-reverse safety device, wherein when the piston rod is pressed downward by the gravity of the bearing seat, the oneway operation unit of the anti-reverse safety device is movable to abut the stop portion to interrupt the connection between the connection portion and the second fluid supply line and to provide an anti-reverse effect to the cylinder to prevent the fluid in the receiving chamber of the cylinder from flowing backward into the second fluid supply line, so that the bearing seat is fixed at a normal position without being lowered down accidentally so as to protect the operator and the vehicle body under the bearing seat.

A further objective of the present invention is to provide an anti-reverse safety device, wherein the anti-reverse safety device provides an anti-reverse effect to the cylinder to maintain the bearing seat at a fixed position so as to protect the operator when the cylinder is worn out or out of control.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a side view of a wheeled vehicle in accordance with the preferred embodiment of the present invention.

FIG. 2 is a locally enlarged view of the wheeled vehicle as shown in FIG. 1.

FIG. 3 is a partially cross-sectional view of the wheeled vehicle as shown in FIG. 2.

FIG. 4 is a schematic operational view of the wheeled vehicle as shown in FIG. 3.

### DETAILED DESCRIPTION OF THE INVENTION

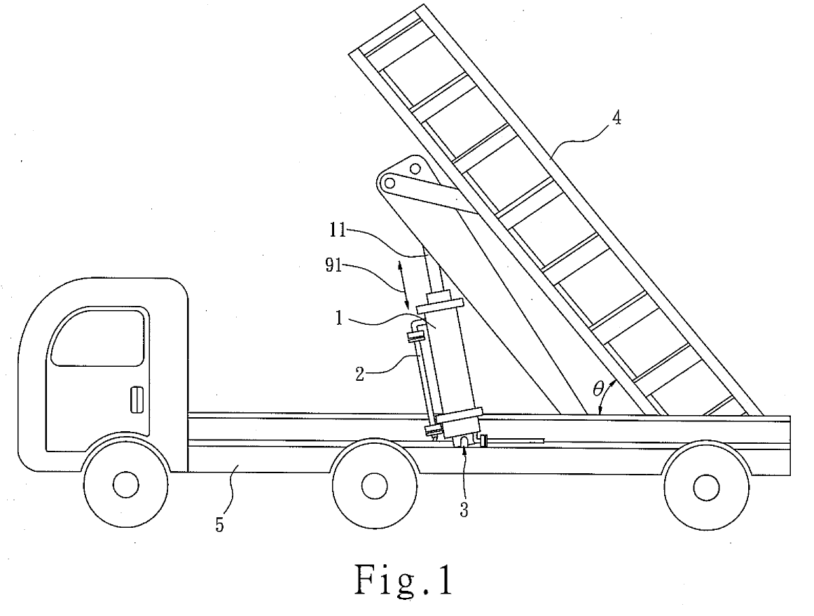

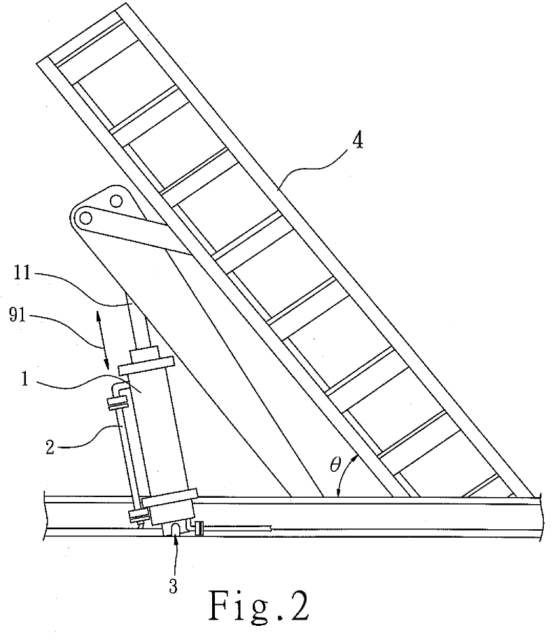

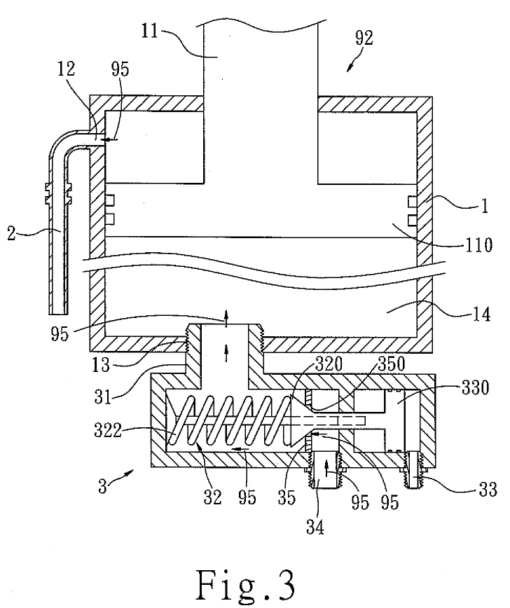

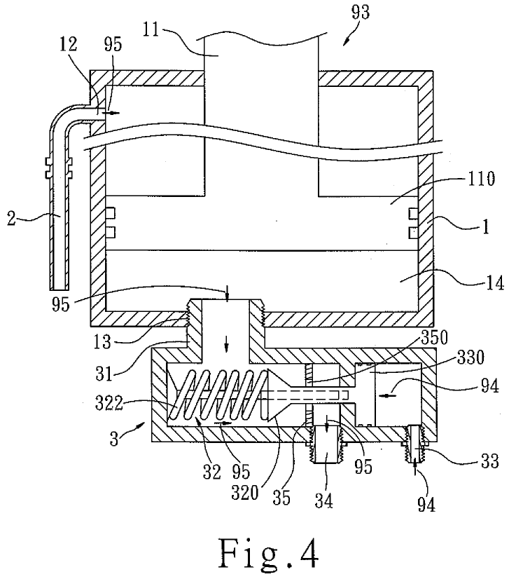

Referring to the drawings and initially to FIGS. 1-3, a wheeled vehicle in accordance with the preferred embodiment of the present invention comprises a vehicle body 5, a bearing seat 4 pivotally mounted on the vehicle body 5, a cylinder 1 mounted on the vehicle body 5 and having an inside having a receiving chamber 14, a first fluid supply line 2 mounted on the cylinder 1 and connected to the receiving chamber 14 of the cylinder 1, a retractable piston rod 11 movably mounted on the cylinder 1 and connected with the bearing seat 4 to perform a linear displacement motion 91 so that the cylinder 1 is disposed between an extended position 92 as shown in FIG. 3 to extend the bearing seat 4 and a retracted position 93 as shown in FIG. 4 to retract the bearing seat 4 so as to adjust an inclined angle “θ” of the bearing seat 4 relative to the vehicle body 5, and an anti-reverse safety device 3 mounted on the cylinder 1 to provide an anti-reverse effect to the cylinder 1 to prevent the cylinder 1 from moving from the extended position 92 into the retracted position 93 automatically.

The anti-reverse safety device 3 includes a connection portion 31 connected to the receiving chamber 14 of the cylinder 1, a second fluid supply line 34 spaced from and connected to the connection portion 31, a one-way operation unit 32 movably mounted between the connection portion 31 and the second fluid supply line 34 and movable to a first position to interrupt a connection between the connection portion 31 and the second fluid supply line 34, an air supply line 33 connected to the oneway operation unit 32 to drive and move the oneway operation unit 32 to a second position to connect the connection portion 31 with the second fluid supply line 34, a stop portion 35 connected between the connection portion 31 and the second fluid supply line 34 to stop a movement of the oneway operation unit 32 when the one-way operation unit 32 is movable to abut the stop portion 35 to interrupt the connection between the connection portion 31 and the second fluid supply line 34, and a movable push member 330 connected with the oneway operation unit 32 and driven by the air supply line 33 to drive and move the oneway operation unit 32 to space from the stop portion 35 so as to connect the connection portion 31 with the second fluid supply line 34.

The stop portion 35 of the anti-reverse safety device 3 has a connection hole 350 connected between the connection portion 31 and the second fluid supply line 34.

The oneway operation unit 32 of the anti-reverse safety device 3 includes a tapered seal member 320 movable to seal the connection hole 350 of the stop portion 35 to interrupt the connection between the connection portion 31 and the second fluid supply line 34, and a biasing member 322 pressing the seal member 320 to push the seal member 320 toward the connection hole 350 of the stop portion 35.

The air supply line 33 of the anti-reverse safety device 3 allows passage of pressurized air 94 to push the movable push member 330 toward the oneway operation unit 32 and to push the oneway operation unit 32 to space from the stop portion 35.

The second fluid supply line 34 of the anti-reverse safety device 3 allows a fluid 95, such as hydraulic liquid, to flow from the second fluid supply line 34 through the stop portion 35, the oneway operation unit 32 and the connection portion 31 into the receiving chamber 14 of the cylinder 1 or from the receiving chamber 14 of the cylinder 1 through the connection portion 31, the oneway operation unit 32 and the stop portion 35 into the second fluid supply line 34.

The piston rod 11 has a lower end provided with a pusher 110 movable in the receiving chamber 14 of the cylinder 1 to separate the first fluid supply line 2 from the connection portion 31 of the anti-reverse safety device 3.

The cylinder 1 has a first side having a first opening 12 connected between the receiving chamber 14 of the cylinder 1 and the first fluid supply line 2 and a second side having a second opening 13 connected between the receiving chamber 14 of the cylinder 1 and the connection portion 31 of the anti-reverse safety device 3.

The first fluid supply line 2 allows the fluid 95 to flow from the first fluid supply line 2 into the receiving chamber 14 of the cylinder 1 or from the receiving chamber 14 of the cylinder 1 into the first fluid supply line 2.

As shown in FIG. 3, the fluid 95 flows from the second fluid supply line 34 of the anti-reverse safety device 3 through the stop portion 35, the oneway operation unit 32 and the connection portion 31 of the anti-reverse safety device 3 into the receiving chamber 14 of the cylinder 1 to push the piston rod 11 upward so that the cylinder 1 is disposed at the extended position 92 to lift the bearing seat 4. At this time, the fluid 95 at the upper portion of the receiving chamber 14 of the cylinder 1 is pushed by the pusher 110 of the piston rod 11 to flow through the first opening 12 of the cylinder 1 into the first fluid supply line 2.

When the piston rod 11 is pressed downward by the gravity of the bearing seat 4, the oneway operation unit 32 of the anti-reverse safety device 3 is movable to abut the stop portion 35 to interrupt the connection between the connection portion 31 and the second fluid supply line 34 and to provide an anti-reverse effect to the cylinder 1 to prevent the fluid 95 in the receiving chamber 14 of the cylinder 1 from flowing backward into the second fluid supply line 34, so that the bearing seat 4 is fixed at a normal position without being lowered down accidentally.

As shown in FIG. 4, the pressurized air 94 flows through the air supply line 33 of the anti-reverse safety device 3 to push the movable push member 330 toward the oneway operation unit 32 and to push the one-way operation unit 32 to space from the stop portion 35 so as to connect the connection portion 31 with the second fluid supply line 34 again. In such a manner, the fluid 95 flows from the receiving chamber 14 of the cylinder 1 through the connection portion 31, the oneway operation unit 32 and the stop portion 35 into the second fluid supply line 34 of the anti-reverse safety device 3 to lower down the piston rod 11 so that the cylinder 1 is disposed at the retracted position 93 to lower down the bearing seat 4. At this time, the fluid 95 from the first fluid supply line 2 flows through the first opening 12 of the cylinder 1 into the upper portion of the receiving chamber 14 of the cylinder 1.

Accordingly, when the piston rod 11 is pressed downward by the gravity of the bearing seat 4, the oneway operation unit 32 of the anti-reverse safety device 3 is movable to abut the stop portion 35 to interrupt the connection between the connection portion 31 and the second fluid supply line 34 and to provide an anti-reverse effect to the cylinder 1 to prevent the fluid 95 in the receiving chamber 14 of the cylinder 1 from flowing backward into the second fluid supply line 34, so that the bearing seat 4 is fixed at a normal position without being lowered down accidentally so as to protect the operator and the vehicle body 5 under the bearing seat 4. In addition, the anti-reverse safety device 3 provides an anti-reverse effect to the cylinder 1 to maintain the bearing seat 4 at a fixed position so as to protect the operator when the cylinder 1 is worn out or out of control.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A wheeled vehicle, comprising:
a cylinder having an inside having a receiving chamber;
a first fluid supply line mounted on the cylinder and connected to the receiving chamber of the cylinder;
a retractable piston rod movably mounted on the cylinder to perform a linear displacement motion so that the cylinder is disposed between an extended position and a retracted position;
an anti-reverse safety device mounted on the cylinder to provide an anti-reverse effect to the cylinder to prevent the cylinder from moving from the extended position into the retracted position automatically.

2. The wheeled vehicle in accordance with claim 1, wherein the anti-reverse safety device includes:
a connection portion connected to the receiving chamber of the cylinder;
a second fluid supply line spaced from and connected to the connection portion;
a oneway operation unit movably mounted between the connection portion and the second fluid supply line and movable to a first position to interrupt a connection between the connection portion and the second fluid supply line;
an air supply line connected to the oneway operation unit to drive and move the oneway operation unit to a second position to connect the connection portion with the second fluid supply line.

3. The wheeled vehicle in accordance with claim 2, wherein the anti-reverse safety device further includes
a stop portion connected between the connection portion and the second fluid supply line to stop a movement of the oneway operation unit when the oneway operation unit is movable to abut the stop portion to interrupt the connection between the connection portion and the second fluid supply line.

4. The wheeled vehicle in accordance with claim 2, wherein the cylinder has a first side having a first opening connected between the receiving chamber of the cylinder and the first fluid supply line and a second side having a second opening connected between the receiving chamber of the cylinder and the connection portion of the anti-reverse safety device.

5. The wheeled vehicle in accordance with claim 3, wherein the anti-reverse safety device further includes a movable push member connected with the oneway operation unit and driven by the air supply line to drive and move the oneway operation unit to space from the stop portion so as to connect the connection portion with the second fluid supply line.

6. The wheeled vehicle in accordance with claim 5, wherein the air supply line of the anti-reverse safety device allows passage of pressurized air to push the movable push member toward the oneway operation unit and to push the oneway operation unit to space from the stop portion.

7. The wheeled vehicle in accordance with claim 3, wherein
the stop portion of the anti-reverse safety device has a connection hole connected between the connection portion and the second fluid supply line;
the oneway operation unit of the anti-reverse safety device includes a tapered seal member movable to seal the connection hole of the stop portion to interrupt the connection between the connection portion and the second fluid supply line, and a biasing member pressing the seal member to push the seal member toward the connection hole of the stop portion.

8. The wheeled vehicle in accordance with claim 3, wherein the second fluid supply line of the anti-reverse safety device allows a fluid to flow from the second fluid supply line through the stop portion, the one-way operation unit and the connection portion into the receiving chamber of the cylinder or from the receiving chamber of the cylinder through the connection portion, the oneway operation unit and the stop portion into the second fluid supply line.

9. The wheeled vehicle in accordance with claim 8, wherein the fluid flows from the second fluid supply line of the anti-reverse safety device through the stop portion, the oneway operation unit and the connection portion of the anti-reverse safety device into the receiving chamber of the cylinder to push the piston rod upward so that the cylinder is disposed at the extended position.

10. The wheeled vehicle in accordance with claim 9, wherein the oneway operation unit of the anti-reverse safety device is movable to abut the stop portion to interrupt the connection between the connection portion and the second fluid supply line to prevent the fluid in the receiving chamber of the cylinder from flowing backward into the second fluid supply line.

11. The wheeled vehicle in accordance with claim 8, wherein the air supply line of the anti-reverse safety device allows passage of pressurized air to push the oneway operation unit to space from the stop portion.

12. The wheeled vehicle in accordance with claim 11, wherein the pressurized air flows through the air supply line of the anti-reverse safety device to push the oneway operation unit to space from the stop portion so as to connect the connection portion with the second fluid supply line.

13. The wheeled vehicle in accordance with claim 12, wherein the fluid flows from the receiving chamber of the cylinder through the connection portion, the oneway operation unit and the stop portion into the second fluid supply line of the anti-reverse safety device to lower down the piston rod so that the cylinder is disposed at the retracted position to lower down the bearing seat.

14. The wheeled vehicle in accordance with claim 8, wherein the first fluid supply line allows the fluid to flow from the first fluid supply line into the receiving chamber of the cylinder or from the receiving chamber of the cylinder into the first fluid supply line.

15. The wheeled vehicle in accordance with claim 2, wherein the piston rod has a lower end provided with a pusher movable in the receiving chamber of the cylinder to separate the first fluid supply line from the connection portion of the anti-reverse safety device.
